(19) United States
(12) Patent Application Publication
(10) Pub. No.: US 2019/0354852 A1
(43) Pub. Date: Nov. 21, 2019

(54) STRESS INDICATORS ASSOCIATED WITH INSTANCES OF INPUT DATA FOR TRAINING NEURAL NETWORKS

(71) Applicant: Advanced Micro Devices, Inc., Santa Clara, CA (US)

(72) Inventor: Greg Sadowski, Cambridge, MA (US)

(21) Appl. No.: 15/982,756

(22) Filed: May 17, 2018

(51) Int. Cl. G06N 3/08; G06N 3/04

(52) U.S. Cl. CPC G06N 3/08; G06N 3/04

(57) ABSTRACT

An electronic device includes a computational functional block and a controller functional block. The controller functional block receives, along with an instance of input data for training a neural network to perform a specified task, a stress indicator associated with the instance of input data. The controller functional block selects, based on a value of the stress indicator, one or more operations to be performed when training the neural network. The controller functional block causes the computational functional block to perform the one or more operations when training the neural network.

### BACKGROUND

### Related Art

Some electronic devices perform operations for artificial neural networks or, more simply, “neural networks.” Generally, a neural network is a computational structure that includes internal elements having similarities to biological neural networks, such as those in a living creature's brain, that can be trained to perform various types of operations. Neural networks are trained by using known information to configure the internal elements of the neural network so that the neural network can then perform an intended operation on unknown information. For example, a neural network may be trained by using digital images that are known to include images of faces to configure the internal elements of the neural network to react appropriately when subsequently analyzing digital images to determine whether the digital images include images of faces. As another example, a neural network may be trained to generate outputs that include specified patterns (e.g., faces in digital images, audio that includes specified sounds or words, etc.).

Neural networks include, in their internal elements, a set of artificial neurons, or “nodes,” that are interconnected to one another in an arrangement similar to how neurons are interconnected via synapses in a living creature's brain. A neural network can be visualized as a form of weighted graph structure in which the nodes include input nodes, intermediate nodes, and output nodes. Within the neural network, each node other than the output nodes is connected to one or more downstream nodes via a directed edge that has an associated weight, where a directed edge is an interconnection between two nodes on which information travels in a specified direction. During operation, the input nodes receive inputs from an external source and process the inputs to produce input values. The input nodes then forward the input values to downstream intermediate nodes. The receiving intermediate nodes weight the received inputs in accordance with a weight of a corresponding directed edge, i.e., adjust the received inputs such as multiplying by a weighting value, etc. Each intermediate node sums the corresponding weighted received inputs to generate an internal value and processes the internal value using an activation function associated with the intermediate node to produce a result value. The intermediate nodes then forward the result values to downstream intermediate nodes or output nodes, where the result values are weighted in accordance with a weight associated with the corresponding directed edge and processed thereby. In this way, the output nodes generate outputs for the neural network. Continuing the image processing example above, the outputs from the output nodes may be in a form that indicates whether or not a digital image includes an image of a face, such as being a value from 0.1 (very little possibility of including an image of a face) to 0.9 (almost certainly includes an image of a face).

As described above, values forwarded along directed edges between nodes in a neural network are weighted in accordance with a weight associated with each directed edge. By setting the weights associated with the directed edges during a training operation so that desired outputs are generated by the neural network, the neural network can be trained to produce intended outputs such as the above-described identification of faces in digital images. When training a neural network, numerous instances of input data having expected or desired outputs are processed in the neural network to produce actual outputs from the output nodes. Continuing the neural network example above, the instances of input data would include digital images that are known to include (or not) images of faces, and thus for which the neural network is expected to produce outputs that indicate that a face is present (or not) in the images. After each instance of input data is processed in the neural network to produce an actual output, an error value, or “loss,” between the actual output and a corresponding expected output is calculated using mean squared error or another algorithm. The loss is then worked backward through the neural network, or “backpropagated” through the neural network, to adjust the weights associated with the directed edges in the neural network in order to reduce the error for the instance of input data, thereby adjusting the neural network's response to the instance of input data—and all subsequent instances of input data. For example, one backpropagation technique involves computing a gradient of the loss with respect to the weight for each directed edge in the neural network. Each gradient is then multiplied by a training coefficient or “learning rate” to compute a weight adjustment value. The weight adjustment value is next used in calculating an updated value for the corresponding weight, e.g., subtracted from an existing value for the corresponding weight. Although techniques and algorithms have been proposed for training neural networks, there remain opportunities for improving the training of neural networks.

### BRIEF DESCRIPTION OF THE FIGURES

FIG. 1 presents a block diagram illustrating a neural network in accordance with some embodiments.

FIG. 2 presents a block diagram illustrating an electronic device in accordance with some embodiments.

FIG. 3 presents a flowchart illustrating a process for selecting operations to be performed when training a neural network in accordance with some embodiments.

FIG. 4 presents a chart illustrating a number of stress indicator value thresholds and corresponding operations to be performed in accordance with some embodiments.

Throughout the figures and the description, like reference numerals refer to the same figure elements.

### DETAILED DESCRIPTION

The following description is presented to enable any person skilled in the art to make and use the described embodiments, and is provided in the context of a particular application and its requirements. Various modifications to the described embodiments will be readily apparent to those skilled in the art, and the general principles defined herein may be applied to other embodiments and applications. Thus, the described embodiments are not limited to the embodiments shown, but are to be accorded the widest scope consistent with the principles and features disclosed herein.

### Terminology

In the following description, various terms are used for describing embodiments. The following is a simplified and general description of one of these terms. Note that the term may have significant additional aspects that are not recited herein for clarity and brevity and thus the description is not intended to limit the term.

Functional block: functional block refers to a group, collection, and/or set of one or more interrelated circuit elements such as integrated circuit elements, discrete circuit elements, etc. The circuit elements are “interrelated” in that circuit elements share at least one property. For instance, the interrelated circuit elements may be included in, fabricated on, or otherwise coupled to a particular integrated circuit chip or portion thereof, may be involved in the performance of given functions (computational or processing functions, memory functions, etc.), may be controlled by a common control element, etc. A functional block can include any number of circuit elements, from a single circuit element (e.g., a single integrated circuit logic gate) to millions or billions of circuit elements (e.g., an integrated circuit memory), etc.

### Neural Networks

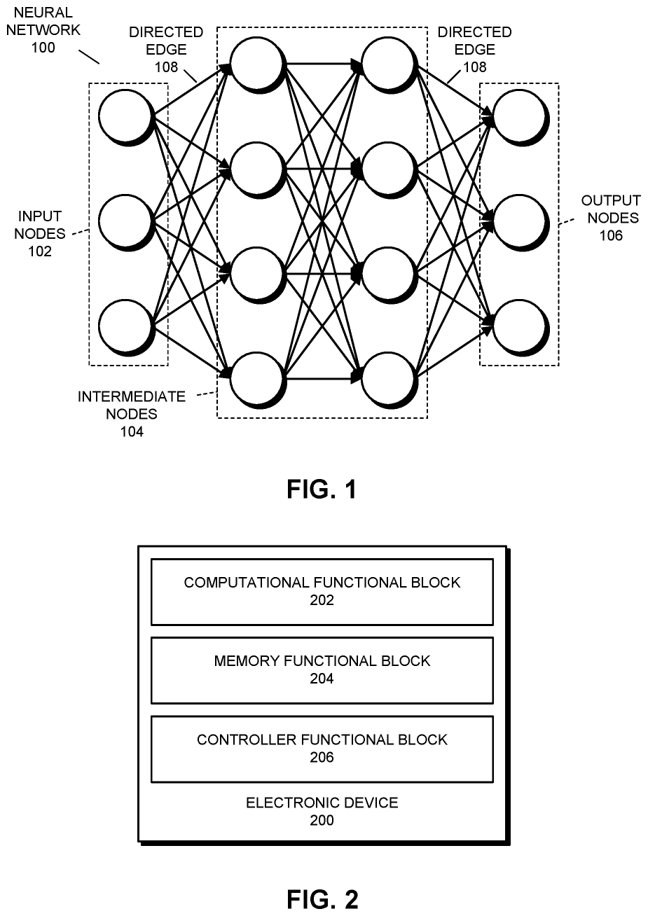

As described above, a neural network is a computational structure that includes internal elements (e.g., nodes, etc.) that are trained to perform specified tasks, such as image recognition or generation, speech recognition or generation, etc. During operation, instances of input data are processed in the neural network to generate outputs or instances of output data from the neural network. FIG. 1 presents a block diagram illustrating a neural network 100 including input nodes 102, intermediate nodes 104, output nodes 106, and directed edges 108 in accordance with some embodiments (note that only two of the directed edges are labeled for clarity).

Although an example of a neural network is presented in FIG. 1, in some embodiments, a different arrangement of nodes and/or layers or levels is used. For example, a neural networks can include a number—and in some cases, a large number—of intermediate nodes arranged in multiple layers or levels, each layer or level of intermediate nodes receiving input values and forwarding generated result values to intermediate nodes in the next layer or level or to the output nodes. As another example, in some embodiments, a different topography or connectivity of nodes is used and/or different types of nodes are used, such as the arrangements of nodes and the nodes themselves used in neural networks including radial basis networks, recurrent neural networks, auto encoders, Markov chains, deep believe networks, deep convolutional networks, generative adversarial networks, deep residual networks, etc. Generally, the described embodiments are operable with any configuration of neural network in which a stress indicator can be used to determine operations to be performed during a training operation as described herein.

Embodiments are described herein using discriminative neural networks, i.e., neural networks that output results indicating likelihoods that instances of input data include a particular pattern, as an example of a neural network. The described embodiments are not limited, however, to discriminative neural networks. For example, in some embodiments, generative neural networks, i.e., neural networks that generate instances of output data that are intended to include a given pattern (e.g., outputs digital images that are intended to include faces or audio that is intended to include particular sounds or words) are trained using stress values. In some of these embodiments, the stress values are associated with instances of output data, particular training iterations, etc. and the loss values may be received from an external source—such as a discriminative network in an generative adversarial network, etc.

### Training Neural Networks

Neural networks can be trained to perform specified tasks, such as image recognition, speech recognition, etc. During training, elements of a neural network are configured for performing the specified task. For example, during training, known instances of input data can be processed to generate outputs and the outputs can be used to iteratively update weight values for elements in the neural network until a suitable final state is reached for the neural network.

There are numerous training algorithms and techniques that can be used to configure a neural network to perform a specified task. For example, in some embodiments, during training, numerous instances of input data having expected or desired outputs are processed in the neural network to produce actual outputs from the output nodes. After each instance of input data is processed in the neural network to produce an actual output, an error value, or “loss,” between the actual output and a corresponding expected output is calculated using mean squared error or another algorithm. The loss is then worked backward through the neural network, or “backpropagated” through the neural network, to adjust the weights associated with the directed edges in the neural network in order to reduce the error for the instance of input data, thereby adjusting the neural network's response to the instance of input data—and all subsequent instances of input data. For example, one backpropagation technique involves computing a gradient of the loss with respect to the weight for each directed edge in the neural network. Each gradient is then multiplied by a training coefficient or “learning rate” to compute a weight adjustment value. The weight adjustment value is used to calculate an updated value for the corresponding weight, e.g., subtracted from an existing value for the corresponding weight.

Although a particular type of training is described above, in some embodiments, at least some different training operations are performed. For example, different techniques may be used to adjust weights, activation function values, and/or other values for the internal elements of neural networks. Generally, the described embodiments are operable with any training algorithm or technique for which a stress indicator can be used to determine operations to be performed during training as described herein.

### Overview

The described embodiments include an electronic device with a controller functional block and computational functional block that perform operations associated with the training of neural networks. In the described embodiments, instances of input data are associated with “stress indicators” that are used to control operations that are performed when training the neural network. A stress indicator is or includes a numerical or other value that is received or acquired by the controller functional block for a given instance of input data. The controller functional block uses the received or acquired stress indicator to select one or more operations to be performed when training the neural network using the given instance of input data (and possibly other instances of input data). In other words, for each of two or more different values of the stress indicator, the controller functional block selects corresponding operation(s) to be performed when training the neural network using the given instance of input data (and possibly other instances of input data).

In the described embodiments, any number of operations can be associated with, and therefore selected, based on any number of values of the stress indicator. In some embodiments, an operation that can be selected based on the value of the stress indicator is a training coefficient update operation. Recall that, during a backpropagation operation for training the neural network, a training coefficient is multiplied by a gradient of a loss with respect to the weight for each directed edge in the neural network to compute a weight adjustment value for the directed edge. For the training coefficient update operation, the training coefficient is adjusted based at least in part on the value of the stress indicator. In some of these embodiments, the training coefficient is set to one of a number of specified training coefficient values based on the value of the stress indicator. In some of these embodiments, the training coefficient is set to a value from a range of values based on the value of the stress indicator, such as being set in proportion to the stress indicator (i.e., the value thereof) or based on a mathematical expression in which the stress indicator is a variable. In some embodiments, other operations that can be selected based on the value of the stress indicator include operations such as: choosing one or more instances of input data from a batch of two or more instances of input data for which one or more training iterations are to be run; adjusting a precision level (e.g., a bit width of operands and/or results) in the computational functional block for one or more operations during one or more training iterations; modifying or replacing one or more activation functions in the neural network; and/or other operations.

In some embodiments, in order to select the operations to be performed, the computational functional block compares the value of the stress indicator to one or more stress indicator value thresholds. In these embodiments, some or all of the operations are associated with specified and possibly different stress indicator value thresholds. For example, the above-described training coefficient update operation may be selected when a value of the stress indicator has a specified relationship with a first stress indicator value threshold (e.g., when the value of the stress indicator is above the first stress indicator value threshold, in a range indicated by the first stress indicator value threshold, etc.). As another example, the above-described adjusting of the precision level in the computational functional block may be selected when a value of the stress indicator is above a second stress indicator value threshold.

By using the values of stress indicators to select the operations to be performed when training a neural network as described, the described embodiments enable given instances of input data to be emphasized or deemphasized and/or otherwise controlled so that the given instances of input data (and possibly other instances of input data) have desired effects on weights and other values in the neural network. In other words, when a given instance of input data is known to have increased importance for the training of the neural network, the associated stress indicator may be set to a relatively higher value (e.g., a higher numerical value) so that corresponding operations are selected for one or more training iterations that involve the given instance of input data. For example, for a neural network that generates outputs indicating the likelihood that digital images include faces, an instance of input data (i.e., a digital image) that includes a full and clearly-defined forward-facing face can be associated with a higher stress indicator so that one or more training iterations that use the instance of input data have relatively more effect on the training of the neural network (e.g., cause larger and/or more adjustments in weight values, etc.), particularly in comparison to less-ideal digital images with less clearly defined faces that are associated with lower stress indicators. This can improve the convergence of training on a desired final state for the neural network (e.g., with particular weights set for directed edges in the neural network, with activation functions configured properly, with the neural network producing relatively accurate outputs, etc.), such as by requiring less training iterations for the convergence. The improved training in turn improves the overall function of an electronic device that includes the computational functional block, which results in higher user satisfaction with the electronic device.

### Electronic Device

FIG. 2 presents a block diagram illustrating an electronic device 200 in accordance with some embodiments. As can be seen in FIG. 2, electronic device 200 includes computational functional block 202, memory functional block 204, and controller functional block 206. As described herein, computational functional block 202, memory functional block 204, and controller functional block 206 perform operations associated with the selection of operations to be performed when training a neural network using stress indicators associated with instances of input data.

Computational functional block 202 is a functional block that performs computational and other operations (e.g., control operations, configuration operations, etc.). For example, computational functional block may be or include a general purpose graphics processing unit (GPGPU), a central processing unit (CPU), an application specific integrated circuit (ASIC), etc. Computational functional block 202 is implemented in hardware, i.e., using various circuit elements and devices. For example, computational functional block 202 can be entirely fabricated on one or more semiconductor chips, can be fabricated from semiconductor chips in combination with discrete circuit elements, can be fabricated from discrete circuit elements alone, etc.

In the described embodiments, included in the operations performed by computational functional block 202 are training operations for a neural network. For example, computational functional block 202 may perform operations such as mathematical, logical, or control operations for processing an instance of input data through the neural network—or feeding the instance of input data forward through the neural network to generate outputs. This can include operations such as evaluating activation functions for nodes in the neural network, computing weighted values, forwarding result values between nodes, etc. Computational functional block 202 may also perform operations for using the outputs generated by the neural network to adjust one or more values in the neural network, i.e., backpropagating a loss value computed from the outputs in order to make adjustments to weight values and/or other values in the neural network. This can include operations such as computing losses for instances of input data, computing gradients of losses with respect to weights in the neural network, etc.

Memory functional block 204 is a memory in electronic device 200 (e.g., a “main” memory), and includes memory circuits such as one or more dynamic random access memory (DRAM), double data rate synchronous DRAM (DDR SDRAM), non-volatile random access memory (NVRAM), and/or other types of memory circuits for storing data and instructions for use by functional blocks in electronic device 200, as well as control circuits for handling accesses of the data and instructions that are stored in the memory circuits. Memory functional block 204 is implemented in hardware, i.e., using various circuit elements and devices. For example, memory functional block 204 can be entirely fabricated on one or more semiconductor chips, can be fashioned from semiconductor chips in combination with discrete circuit elements, can be fabricated from discrete circuit elements alone, etc.

Controller functional block 206 is a functional block that performs operations relating to the training of neural networks and possibly other operations. In some embodiments, controller functional block 206 includes processing circuits that use stress indicators associated with instances of input data to select one or more operations to be performed for one or more iterations of training operations for the neural network. For example, controller functional block 206 may compare the stress indicators to one or more stress indicator value thresholds and, based on the comparison, select corresponding operations to be performed when training the neural network.

Although controller functional block 206 is shown separately from the other functional blocks, in some embodiments, controller functional block 206 is not a separate functional block. For example, in some embodiments, the operations described herein as being performed by controller functional block 206 are instead performed by computational functional block 202, such as by general purpose and/or dedicated processing circuits in computational functional block 202.

Although electronic device 200 is simplified for illustrative purposes, in some embodiments, electronic device 200 includes additional or different functional blocks, subsystems, elements, and/or communication paths. For example, electronic device 200 may include display subsystems, power subsystems, I/O subsystems, etc. Electronic device 200 generally includes sufficient functional blocks, etc. to perform the operations herein described.

Electronic device 200 can be, or can be included in, any device that performs computational operations. For example, electronic device 200 can be, or can be included in, a desktop computer, a laptop computer, a wearable computing device, a tablet computer, a piece of virtual or augmented reality equipment, a smart phone, an artificial intelligence (AI) device, a server, a network appliance, a toy, a piece of audio-visual equipment, a home appliance, a vehicle, etc., and/or combinations thereof.

### Instances of Input Data

In the described embodiments, “instances” of input data are used for training a neural network. The nature of the instances of input data depend on the nature of the tasks that the neural network is being trained to perform. For example, if the neural network is being trained to perform speech recognition operations, the instances of input data may be digital audio files or snippets that include (or do not include) speech or other sounds. As described herein, a number of separate instances (pieces, portions, etc.) of input data are typically processed in the neural network in order to iteratively train the neural network to perform the task that the neural network is being trained to perform. For example, many thousands of digital audio files or snippets (each file or snippet being an instance of input data) can be processed in the neural network when training the neural network.

### Stress Indicators

In the described embodiments, stress indicators can be associated with instances of input data. A stress indicator is generally a value such as a numerical value, a string, and/or another representation of value (e.g., a specified number or arrangement of bits) that can be interpreted as described herein for selecting operations to be performed. For example, in some embodiments, stress indicators are set to values from a specified range of values such as 0-3 (which may be expressed using two bits: 00, 01, 10, and 11) or another range of values.

In some embodiments, when an instance of input data is associated with a higher-valued stress indicator, the instance of input data is being emphasized and/or is otherwise to be used in specified ways when training the neural network. In these embodiments, instances of input data are “emphasized” in that the instances of input data have more pronounced effects on the training of the neural network (i.e., relative to instances of input data that are associated with lower-valued stress indicators). For example, when instances of input data are associated with higher-valued stress indicators, using higher training coefficient values, larger weight adjustments may be made based on the instances of input data, more training iterations may be run using the instances of input data, different activation functions or activation function parameters may be used when processing the instances of input data in the neural network during training iterations, etc. In this way, instances of input data that are known to be more relevant or are otherwise important may be configured to make larger changes to the neural network during training.

Although examples are provided herein in which stress indicators are associated with instances of input data, not every instance of input data is required to be associated with a stress indicator. For instances of input data that are not associated with a stress indicator, a default stress indicator or no stress indicator may be used. In some embodiments, when no stress indicator is associated with an instance of input data, a “default” iteration of training is performed. For a default iteration of training, the training iteration is performed without performing the additional operations described herein (e.g., the adjustment of the training coefficient, the processing of particular instances of input data, etc.). For example, when no stress indicator is associated with an instance of input data, a training coefficient may be set to a default value, a single training iteration may be run with the instance of input data, normal or default activation functions may be used, etc. In some embodiments, the above-described default iterations of training are performed not only for instances of input data that are not associated with stress indicators, but also for instances of input data that are associated with at least some lower-valued stress indicators.

In some embodiments, the controller functional block receives or acquires stress indicators from specified locations and/or sources. For example, a stress indicator may be stored as metadata associated with an instance of input data, such as being stored in memory in a location used for storing metadata for the instance of input data (e.g., in a contiguous region of memory with the instance of input data, in a location in memory that is known to store metadata for the instance of input data, etc.). As another example, an instance of input data may include the stress indicator in a field or other record within the instance of input data itself or otherwise embedded or encoded in the instance of input data. As yet another example, the stress indicator may be stored in a register or other memory element in a computational element (e.g., written to a register as the output of a previous operation and/or by another hardware or software entity, etc.). In some embodiments, computational elements used for training neural networks include dedicated registers or memory elements for locally storing stress indicators, which can improve the speed of operations that rely on the stress indicators (including computation of training coefficients, etc.). As yet another example, a user, a hardware entity, or a software entity may provide a list, table, or other record of stress indicators associated with one or more instances of input data. As yet another example, a software application or hardware entity that is providing instances of input data for the training of the neural network and/or otherwise controlling the training of the neural network may provide stress indicators. As yet another example, the instance of input data and/or the stress indicator may be received via a communication interface such as a bus or communication route.

Selecting Operations to be Performed when Training a Neural Network

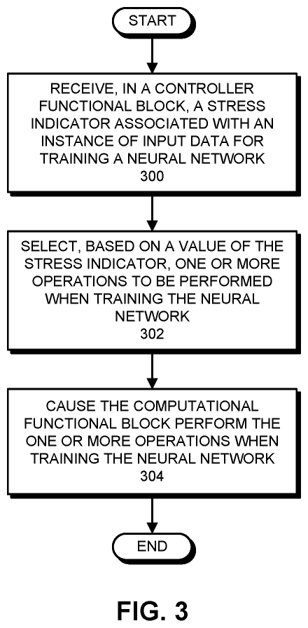

The described embodiments select operations to be performed when training a neural network based on stress indicators associated with instances of input data. FIG. 3 presents a flowchart illustrating a process for selecting operations to be performed when training a neural network in accordance with some embodiments. Note that the operations shown in FIG. 3 are presented as a general example of functions performed by some embodiments. The operations performed by other embodiments include different operations and/or operations that are performed in a different order. Additionally, although certain mechanisms are used in describing the process (e.g., controller functional block 206, computational functional block 202, etc.), in some embodiments, other mechanisms can perform the operations.

The process shown in FIG. 3 starts when a controller functional block (e.g., controller functional block 206) receives a stress indicator associated with an instance of input data for training a neural network (step 300). For example, the controller functional block may acquire the stress indicator from a memory (e.g., memory functional block 204) or from a dedicated register, may receive the stress indicator on a communication interface, may extract or decode the stress indicator from the instance of input data, etc.

For the example in FIG. 3, step 300 involves receiving, as the stress indicator, a numerical or other value that represents a value of the stress indicator. For example, the stress indicator may be a four-bit value in which each bit represents a separate value of the stress indicator, so that the value of the stress indicator can be between 0-4 as 0000, 0001, 0010, 0100, and 1000. As another example, the stress indicator may be a two-bit value in which respective numerical values represent the different values of the stress indicator, so that the values of the stress indicator can be between 0 and 3 (bits set as 00, 01, 10, and 11 from 0-3).

The controller functional block then selects, based on the value of the stress indicator, one or more operations to be performed when training the neural network (step 302). During this operation, the controller functional block compares the value (e.g., absolute value, relative value, etc.) of the received stress indicator to one or more stress indicator value thresholds to determine which operations are to be performed (or not be performed) when training the neural network for training iterations involving at least the instance of input data. For example, in some embodiments, the controller functional block includes a record (e.g., list, table, etc.) of stress indicator value thresholds and one or more operations that are associated with each stress indicator value threshold. In this case, the controller functional block separately compares the value of the received stress indicator to at least some of the recorded stress indicator value thresholds to determine if the value of the stress indicator has a specified relationship with that stress indicator value threshold (e.g., is above that stress indicator value threshold, in a range indicated by that stress indicator value threshold, etc.), and thus the corresponding operations are to be performed. As another example, one or more stress indicator value thresholds may be stored in registers or memory locations that are known by the controller functional block (e.g., known in advance, specified by convention, etc.) to be associated with one or more operations to be performed. In this case, the controller functional block separately compares the value of the received stress indicator to each stored stress indicator value threshold to determine if the value of the stress indicator has a specified relationship with that stress indicator value threshold (e.g., is above that stress indicator value threshold, in a range indicated by that stress indicator value threshold, etc.), and thus the corresponding operations are to be performed.

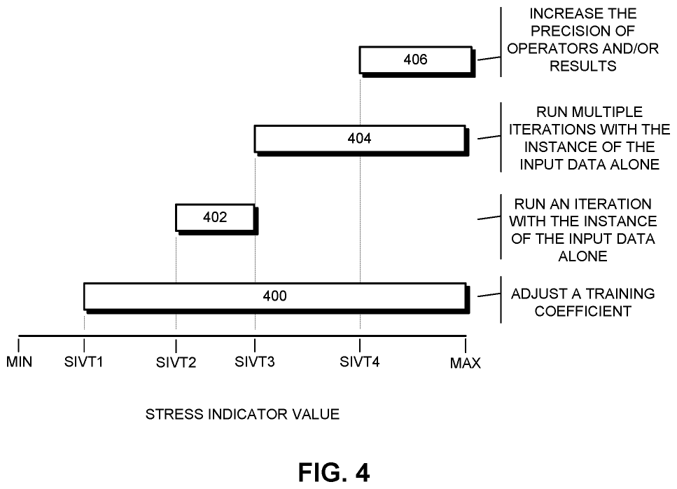

In the described embodiments, any number of stress indicator value thresholds may be associated with any number of operations that may be performed when training the neural network. FIG. 4 presents a chart illustrating a set of stress indicator value thresholds, SIVT1-SIVT4 (i.e., stress indicator value thresholds 1-4), and corresponding operations to be performed in accordance with some embodiments. For the example presented in FIG. 4, the stress indicator value axis includes stress indicator value values between a minimum value (MIN), e.g., 0, 10, or another value, and a maximum value (MAX), e.g., 4, 100, or another value. Note that the example shown in FIG. 4 one arrangement of stress indicator value thresholds and corresponding operations to be performed, but other embodiments use other arrangements of stress indicator value thresholds and/or corresponding operations to be performed.

In some embodiments, a user, a hardware entity, and/or a software entity sets, and possibly resets, the stress indicator value thresholds statically (e.g., before electronic device 200 performs certain initialization operations, before specified software begins execution, etc.) and/or dynamically (e.g., at runtime, as electronic device 200 operates, as specified software is executing, etc.). Generally, the stress indicator value thresholds can be set in order to cause corresponding operations to selectively be performed when training neural networks. For example, a user or other entity may determine that a training coefficient is to be adjusted for stress indicators having a value above a given value (e.g., to emphasize or deemphasize selected instances of input data) and set a stress indicator value threshold associated with the training coefficient adjusting operation accordingly. The stress indicator value thresholds can be set for any of various reasons, such as based on an estimated or known outcome of the effect on the training of the neural network of setting a given stress indicator value threshold to a particular value. Such an effect may be determined based at least in part on one or more previous training iterations, empirical or theoretical computations or estimations, a number of training iterations to be performed, a rate of convergence of training iterations on final values, a desired effect of particular instances of input data, a nature or arrangement of the neural network or the training algorithm or technique, and/or for other reasons. In some embodiments, a hardware and/or software entity monitors performance metrics (e.g., number of iterations, final results, processing speed, etc.) for at least a portion of the training operations for a neural network and updates some or all of the stress indicator value thresholds accordingly. For example, to speed up or render more accurate the training operations.

As shown by the bottommost bar 400 in FIG. 4, when the value of the stress indicator exceeds SIVT1, the controller functional block adjusts a training coefficient. For the adjustment, the controller functional block changes, if necessary, the training coefficient that is used when computing weight values for directed edges when backpropagating loss information through the neural network from a first value to a second value. When the value of the stress indicator is below or equal to SIVT1, no adjustment is made to the training coefficient, and thus the controller functional block uses an existing, default, or other specified value of the training coefficient (e.g., 0.001 or another value). When the value of the stress indicator exceeds SIVT1, however, the controller functional block adjusts the training coefficient to a specified value. In some embodiments, the training coefficient is adjusted to (set to, updated to, etc.) a same value for all stress indicator values above SIVT1. For example, the training coefficient may be set to a value of 0.01 for all for all stress indicator values above SIVT1. In some embodiments, the training coefficient is adjusted to (set to, updated to, etc.) one of two or more different values based on a particular stress indicator value for all stress indicator values above SIVT1. For example, the training coefficient may be set to a value that is computed using a mathematical function of the stress indicator and/or one or more other values. In this case, any appropriate mathematical function may be used to compute a training coefficient in proportion to the stress indicator—so that a range of training coefficient values may be computed between SIVT1 (e.g., a training coefficient value of 0.01) and the maximum stress indicator (e.g., a training coefficient value of 0.1).

As shown by the second from the bottom bar 402 in FIG. 4, when the value of the stress indicator exceeds SIVT2, but is below SIVT3, the controller functional block causes the computational functional block to run an iteration of training with the instance of the input data alone. When the value of the stress indicator is equal to or below SIVT2, the controller functional block causes the computational functional block to run a training iteration with each instance/all instances of input data from a batch of instances of input data. In other words, the controller functional block causes the computational functional block, for each instance of input data from a batch of instances of input data, to process the instance of input data forward through the neural network to generate an output and then backpropagate corresponding loss information through the neural network to adjust weights for directed edges. In this way, when the value of the stress indicator is equal to or below SIVT2, all of the instances of the input data in the batch of instances of input data are used to iteratively adjust the weights of the directed edges. When the value of the stress indicator exceeds SIVT2 but is below SIVT3, however, the controller functional block causes the computational functional block to run a training iteration with only the single instance of input data. Again, the controller functional block causes the computational functional block to process the single instance of input data forward through the neural network to generate an output and then backpropagate corresponding loss information through the neural network to adjust weights for directed edges. In this way, only the one instance of input data is used to adjust the weights of the directed edges, which can avoid other instances from the batch of instances—which would have been separately processed for training the neural network had the stress indicator been less than SIVT2—negating or otherwise altering the effect of processing the single instance of input data.

Note that, for stress indicator values above SIVT2, at least two operations are selected and performed: the adjustment of the training coefficient that occurs for stress indicator values above SIVT1 and running the training iteration with only the one instance of the input data for stress indicator values above SIVT2. In this way, for higher stress indicator values, multiple operations can be performed, which can help to emphasize or otherwise control the effect of certain instances of input data. In the described embodiments, any number of operations can be selected concurrently or simultaneously based on the value of a stress indicator.

As shown by the second from the top bar 404 in FIG. 4, when the value of the stress indicator is above SIVT3, the controller functional block causes the computational functional block to run multiple iterations of training with the instance of the input data alone. When the value of the stress indicator is equal to or below SIVT3, the controller functional block causes the computational functional block to run a training iteration with each instance of input data from a batch of instances of input data or with only the single instance of input data—depending on whether the value of the stress indicator is above SIVT2, as described above. Otherwise, when the value of the stress indicator is above SIVT3, the controller functional block causes the computational functional block to run multiple training iterations with only the single instance of input data. In other words, until a specified number of iterations have been performed, the controller functional block causes the computational functional block to process the single instance of input data forward through the neural network to generate an output and then backpropagate corresponding loss information through the neural network to adjust weights for directed edges. In these embodiments, the number of iterations can be a single specified value, can be computed based on the value of the stress indicator, etc. In this way, only the one instance of input data is used to repeatedly adjust the weights of the directed edges, which can reinforce the effect of the instance of input data and may avoid other instances from the batch of instances—which would have been separately processed for training the neural network if the stress indicator was less than SIVT2—negating or otherwise altering the effect of processing the single instance of input data.

In some embodiments, instead of the operations of running a single training iteration or multiple training iterations with only the instance of input data as described above for the SIVT2 and SIVT3 thresholds, the described embodiments may run training iterations for a subset of a batch of instances of input data (which may include the instance of input data). For example, in some embodiments, the controller functional block selects, based on one or more criteria (e.g., associated stress indicators, data identifiers, arrangements of the batch of instances of input data, randomly, etc.), a subset of instances of input data in a batch of instances of input data (e.g., five hundred instances of input data from a batch of ten thousand instances of input data, etc.). The controller functional block then causes the computational functional block to, based on the value of the stress indicator, run either a single training iteration for each of the selected instances of input data or run multiple training iterations for each of the selected instances of input data. In some embodiments, separate stress indicator value thresholds, other than SIVT2 and SIVT3, (not shown) are used for determining whether or not subsets of the batch of instances of input data are to have a specified number of training instances run. In some of these embodiments, stress indicators are associated with each instance of input data in the batch of instances of input data, and may result in at least some differences in operations that are performed when performing the training iterations for a given instance of input data (e.g., adjustments to training coefficients, etc.). In other words, stress indicators for such embodiments may have a nested effect, with a subset of a batch of instances of input data being selected based on a primary stress indicator and a particular instance of input data within the subset being handled based at least in part on the associated and secondary stress indicator, similarly to what is otherwise described herein.

As shown by the topmost bar 406 in FIG. 4, when the value of the stress indicator is above SIVT4, the controller functional block increases the precision of operands and/or results used for performing the multiple training iterations using the instance of input data. For this operation, the controller functional block can, as the electronic device operates, configure/reconfigure the computational functional block to use a particular operand and/or result precision level (or bit width) among a set of two or more operand and/or result precision levels. The precision levels, and thus the bit widths used for operands and/or results, can include any bit width that can be operated on by the computational functional block, from 1 bit to 256 bits and more. In some embodiments, when configuring the computational functional block to use a given precision level for executing a workload, circuit elements that are not used for executing the workload at the precision level are disabled, halted, or otherwise configured to reduce power consumption, heat generated, etc. (e.g., via reduced voltages, clock speeds, etc.). For example, the computational functional block may include separate circuit elements configured to operate using operands and/or results of each respective precision level, such as a separate ALU, compute unit, or execution pipeline for each precision level. In these embodiments, the separate circuit elements are enabled or disabled based on the precision level for which the computational functional block is configured. As another example, the computational functional block may include a set of circuit elements that are operable at various precision levels via enabling/disabling subsets of circuit elements within the single set of circuit elements, such as an N bit-wide ALU (where N is 256, 128, 64, or another number) that can be configured via disabling respective subsets of circuit elements to operate on operands having numbers of bits less than N. When the value of the stress indicator is below SIVT4, the controller functional block causes the computational functional block to run one or more training iterations with specified instances of input data at a first or default precision level (e.g., single floating point operands and/or results)—depending on whether the value of the stress indicator is above SIVT2 or SIVT3, as described above. Otherwise, when the value of the stress indicator is above SIVT4, the controller functional block causes the computational functional block to run multiple training iterations with only the single instance of input data (due to SIVT3) at a second or increased precision level (e.g., double floating point operands and/or results). In this way, higher precisions of operands and/or result values can optionally be used to control the precision of the training iterations.

As described above, although a particular embodiment is shown in FIG. 4, other embodiments have other arrangements of stress indicator value thresholds and/or corresponding operations to be performed. For example, in some embodiments, one or more stress indicator value thresholds may be associated with operations for adjusting and/or changing activation functions associated with nodes in the neural network. In some of these embodiments, operand values (e.g., constants, biases, offset values, multiplicands/divisors, etc.) for some or all of the activation functions in a neural network are dynamically adjusted based on whether the value of the stress indicator exceeds a corresponding stress indicator value threshold. In some of these embodiments, alternative activation functions are swapped in for default activation functions for nodes in the neural network when the value of the stress indicator exceeds a corresponding stress indicator value threshold. In this way, based on the stress indicator associated with a given instance of input data, the response of some or all of the nodes in the neural network to input values can be controlled via changes to the nodes' activation function.

In addition, although ranges of stress indicator values are shown for several of the operations, in some embodiments, the thresholds are set differently. For example, the thresholds may be set so that a given operation alone is performed, such as by having other operations associated with thresholds that are not continuous. This can be seen in FIG. 4 in the SIVT2 and SIVT3 thresholds, as the corresponding operations are separated using a particular range for the threshold of the “run an iteration with the instance of input data alone” operation (SIVT2). Generally, the thresholds can be set so that particular operations are selected at given stress indicator values and otherwise not selected, and the thresholds need not overlap.

Returning to FIG. 3, the controller functional block then causes the computational functional block to perform the one or more operations when training the neural network (step 304). As described above, and depending on the operations selected, the computational functional block performs a selected number of training iterations on some or all of a batch of instances of input data, possibly with the training coefficient set to a specified value, the operand and/or result precision increased, etc.

In some embodiments, an electronic device (e.g., electronic device 200, and/or some portion thereof) uses code and/or data stored on a non-transitory computer-readable storage medium to perform some or all of the operations herein described. More specifically, the electronic device reads the code and/or data from the computer-readable storage medium and executes the code and/or uses the data when performing the described operations. A computer-readable storage medium can be any device, medium, or combination thereof that stores code and/or data for use by an electronic device. For example, the computer-readable storage medium can include, but is not limited to, volatile memory or non-volatile memory, including flash memory, random access memory (eDRAM, RAM, SRAM, DRAM, DDR, DDR2/DDR3/DDR4 SDRAM, etc.), read-only memory (ROM), and/or magnetic or optical storage mediums (e.g., disk drives, magnetic tape, CDs, DVDs).

In some embodiments, one or more hardware modules are configured to perform the operations herein described. For example, the hardware modules can include, but are not limited to, one or more processors/cores/central processing units (CPUs), application-specific integrated circuit (ASIC) chips, field-programmable gate arrays (FPGAs), compute units, embedded processors, graphics processors (GPUs)/graphics cores, pipelines, Accelerated Processing Units (APUs), system management units, power controllers, and/or other programmable-logic devices. When such hardware modules are activated, the hardware modules perform some or all of the operations. In some embodiments, the hardware modules include one or more general purpose circuits that are configured by executing instructions (program code, firmware, etc.) to perform the operations.

In some embodiments, a data structure representative of some or all of the structures and mechanisms described herein (e.g., computational functional block 202, controller functional block 206, and/or some portion thereof) is stored on a non-transitory computer-readable storage medium that includes a database or other data structure which can be read by an electronic device and used, directly or indirectly, to fabricate hardware including the structures and mechanisms. For example, the data structure may be a behavioral-level description or register-transfer level (RTL) description of the hardware functionality in a high level design language (HDL) such as Verilog or VHDL. The description may be read by a synthesis tool which may synthesize the description to produce a netlist including a list of gates/circuit elements from a synthesis library that represent the functionality of the hardware including the above-described structures and mechanisms. The netlist may then be placed and routed to produce a data set describing geometric shapes to be applied to masks. The masks may then be used in various semiconductor fabrication steps to produce a semiconductor circuit or circuits (e.g., integrated circuits) corresponding to the above-described structures and mechanisms. Alternatively, the database on the computer accessible storage medium may be the netlist (with or without the synthesis library) or the data set, as desired, or Graphic Data System (GDS) II data.

In this description, variables or unspecified values (i.e., general descriptions of values without particular instances of the values) are represented by letters such as N. As used herein, despite possibly using similar letters in different locations in this description, the variables and unspecified values in each case are not necessarily the same, i.e., there may be different variable amounts and values intended for some or all of the general variables and unspecified values. In other words, N and any other letters used to represent variables and unspecified values in this description are not necessarily related to one another.

The foregoing descriptions of embodiments have been presented only for purposes of illustration and description. They are not intended to be exhaustive or to limit the embodiments to the forms disclosed. Accordingly, many modifications and variations will be apparent to practitioners skilled in the art. Additionally, the above disclosure is not intended to limit the embodiments. The scope of the embodiments is defined by the appended claims.

What is claimed is:

1. An electronic device, comprising:
a hardware computational functional block; and
a controller functional block, the controller functional block configured to:
receive a stress indicator associated with an instance of input data for training a neural network to perform a specified task;
select, based on a value of the stress indicator, one or more operations to be performed when training the neural network; and
cause the computational functional block to perform the one or more operations when training the neural network.

2. The electronic device of claim 1, wherein selecting the one or more operations comprises:
for each candidate operation from among one or more candidate operations:
comparing the value of the stress indicator to a threshold associated with the candidate operation; and
when the value of the stress indicator has a specified relationship with the threshold associated with the candidate operation, selecting the candidate operation as one of the one or more operations.

3. The electronic device of claim 2, wherein a candidate operation from among the one or more candidate operations comprises:
adjusting, based at least in part on the value of the stress indicator, a training coefficient that is used for computing weighting values for inputs to nodes in the neural network.

4. The electronic device of claim 3, wherein adjusting the training coefficient comprises:
setting the training coefficient in proportion to the stress indicator, thereby causing, when computing the weighting values, relatively larger modifications of the weighting values for higher values of the stress indicator.

5. The electronic device of claim 2, wherein:
the instance of input data is an instance of input data from a batch of input data that includes at least two different instances of input data; and
a candidate operation from among the one or more candidate operations comprises:
instead of performing training iterations for each of the at least two different instances of input data, performing a training iteration with only the instance of input data.

6. The electronic device of claim 2, wherein:
the instance of input data is an instance of input data from a batch of input data that includes at least two different instances of input data; and
a candidate operation from among the one or more candidate operations comprises:
instead of performing training iterations for each of the at least two different instances of input data, performing multiple training iterations with only the instance of input data.

7. The electronic device of claim 2, wherein:
the instance of input data is an instance of input data from a batch of input data that includes a plurality of different instances of input data; and
a candidate operation from among the one or more candidate operations comprises:
instead of performing training iterations for each of the plurality of different instances of input data, performing one more training iterations with each of a subset of instances of input data from the batch of input data, the subset including the instance of input data.

8. The electronic device of claim 2, wherein a candidate operation from among the one or more candidate operations comprises:
increasing a precision level of at least one of operands and results for specified computations for training the neural network.

9. The electronic device of claim 2, wherein a candidate operation from among the one or more candidate operations comprises:
modifying or replacing, based at least on part on the value of the stress indicator, one or more activation functions in the neural network.

10. The electronic device of claim 1, wherein the stress indicator is set to a given value based on a relative importance of the instance of input data among multiple different instances of input data for training the neural network to perform the specified task.

11. The electronic device of claim 1, further comprising:
a plurality of computational units in the computational functional block, each computational unit being configured to perform computations for training the neural network,
wherein each computational unit comprises circuit elements for at least one of receiving and storing the stress indicator to be used for one or more computations involving the instance of input data when training the neural network.

12. A method for training a neural network in an electronic device that includes a hardware computational functional block and a controller functional block, the method comprising:
in the controller functional block, performing operations for:
receiving a stress indicator associated with an instance of input data for training the neural network to perform a specified task;
selecting, based on a value of the stress indicator, one or more operations to be performed when training the neural network; and
causing the computational functional block to perform the one or more operations when training the neural network.

13. The method of claim 12, wherein selecting the one or more operations comprises:
for each candidate operation from among one or more candidate operations:
comparing the value of the stress indicator to a threshold associated with the candidate operation; and
when the value of the stress indicator has a specified relationship with the threshold associated with the candidate operation, selecting the candidate operation as one of the one or more operations.

14. The method of claim 13, wherein a candidate operation from among the one or more candidate operations comprises:
adjusting, based at least in part on the value of the stress indicator, a training coefficient that is used for computing weighting values for inputs to nodes in the neural network.

15. The method of claim 14, wherein adjusting the training coefficient comprises:
setting the training coefficient in proportion to the stress indicator, thereby causing, when computing the weighting values, relatively larger modifications of the weighting values for higher values of the stress indicator.

16. The method of claim 13, wherein:
the instance of input data is an instance of input data from a batch of input data that includes at least two different instances of input data; and
a candidate operation from among the one or more candidate operations comprises:
instead of performing training iterations for each of the at least two different instances of input data, performing a training iteration with only the instance of input data.

17. The method of claim 13, wherein:
the instance of input data is an instance of input data from a batch of input data that includes at least two different instances of input data; and
a candidate operation from among the one or more candidate operations comprises:
instead of performing training iterations for each of the at least two different instances of input data, performing multiple training iterations with only the instance of input data.

18. The method of claim 13, wherein:
the instance of input data is an instance of input data from a batch of input data that includes a plurality of different instances of input data; and
a candidate operation from among the one or more candidate operations comprises:
instead of performing training iterations for each of the plurality of different instances of input data, performing one more training iterations with each of a subset of instances of input data from the batch of input data, the subset including the instance of input data.

19. The method of claim 13, wherein a candidate operation from among the one or more candidate operations comprises:
increasing a precision level of at least one of operands and results for specified computations for training the neural network.

20. The method of claim 13, wherein a candidate operation from among the one or more candidate operations comprises:
modifying or replacing, based at least on part on the value of the stress indicator, one or more activation functions in the neural network.
